(19) United States
(12) Patent Application Publication
(10) Pub. No.: US 2007/0074273 A1
(43) Pub. Date: Mar. 29, 2007

(54) Method and device for increasing security during data transfer

(76) Inventor: Bill Linden, Uppsala (SE)

Correspondence Address: YOUNG & THOMPSON, 745 SOUTH 23RD STREET, 2ND FLOOR, ARLINGTON, VA, 22202, US

(21) Appl. No.: 11/473,021

(22) Filed: Jun. 23, 2006

(30) Foreign Application Priority Data
Sep. 23, 2005 (SE) 0502102-7

(51) Int. Cl. H04L 9/32

(52) U.S. Cl. 726/3

(57) ABSTRACT

The present invention relates to a method for presenting information in connection with the distribution of the same via the Internet and/or other media, whereby the information is in the form of a quantity of characters (0), whereby the information is transferred from an information giver (I-GIV) to an information recipient (I-REC), whereby the information is transferred in at least two Sessions that, in the first Session, the information giver (I-GIV) fills out the initial entry form (IEF), that a first partial quantity of the total quantity of characters is entered into the initial entry form (IEF), that the information in the completed initial entry form (IEF) is transferred from the information giver (I-GIV) to an information recipient (I-REC), that the information giver (I-GIV) fills out a second entry form (SEF)in a second Session, that a second partial quantity of characters of the total quantity is entered into the second entry form (SEF), and that additional sessions of data transfer take place as needed via the completion of additional entry forms (SEF), until the entire quantity of characters has been transmitted from the information giver (I-GIV) to the information recipient (I-REC). The invention also relates to a hardware device associated with the method.

It is significant of the method according to the invention that I-GIV fills out the partial character quantity associated with each session in randomly generated open entry windows (R1, R2, R3, etc.) in the entry forms (IEF, SEF), and that closed entry windows (S1, S2, S3, etc.) are provided between certain of the open entry windows (R1, R2, R3, etc.) in the entry form (IEF, SEF).

### TECHNICAL FIELD OF THE INVENTION

The invention refers to a first embodiment, hereinafter referred to as EMB 1, in the shape of a simple software method as well as, in a more advanced embodiment, hereinafter referred to as EMB 2, a device that both prevents data theft during data transfer over any medium, and, in connection with this, ensures authentication between authorized parties, eliminating phishing, pharming, prevents from eavesdropping and deciphering of encrypted data after wire tap and stops “man in the middle” scenarios as successful pharming cannot be made.

Definitions

An Alias is referred to below as an IP-Alias, and is a name chosen to conceal one's real name, i.e. a type of Internet pseudonym or “facade.”

In the present invention, a Device is a communication box that contains both processing power and a removable, unique SIM card (or similar SmartCard, Data Chip Card) for its functionality. The device cannot work as intended without the presence of the card unique to the Device, and the card will not work in another Device.

ATM, short for Automated Teller Machine, allowing customers to perform banking transactions anywhere and at anytime, is the international designation for the cash service equipment known in Europe as a “Bankomat”.

An attraction site is a site on the Internet or another medium attractive for purposes of data theft, and which is identified by infectious spy software in PCs for criminal exploitation. The attraction site may be a website or other site of activity, which is often maintained by an I-REC (information recipient) to which an I-GIV (information giver) wants to connect to the end of e-commerce, financial services (Internet banking) or other data communication (military or other). An attraction site may be a frequently loaded web page, such as an order page, and/or page in closed networks (such as business to business networks,B2B). An attraction site is characterized by the fact that it always imposes identification requirements on at least I-GIV.

Authentication is a process between I-GIV and I-REC intended for one to be able to identify the other and vice versa.

Blanks are positions that do not contain information visible to the user.

Bots or Botnets: An abbreviation for “Robotic Networks” consisting of groups (clusters) of PC Zombies controlled remotely for orchestrated attacks, such as mass withdrawals of Internet bank accounts, mass collection of IDs, heavy decryption jobs that require huge amounts of computing power, for transmission of spam, etc. Botnets may require access to Spyware programs that steal IDs from infected and totally vulnerable PCs.

Wire tap refers to illegal eavesdropping on communication between I-GIV and I-REC for the purpose of gaining access to information which the eavesdropper does not have authority to access.

CVV2 code: (CVC2 or CV2). The security code (often consisting of 3 or 4 digits) printed separately on I-GIV's bank card in order to corroborate I-GIV's authorization for the card for I-REC's benefit and requirement.

DOP Device Operating System. For mobile Internet phones describing the special operating system software identical to the operating system in the hardware Device.

EMB 1 The primary embodiment of the invention (software operated).

EMB 2 The second, more complex embodiment of the invention (software/Device operated).

Labels are unique, randomly chosen names (E1, E2, E3, etc. [see below]) put in place by I-REC. Labels are placed on Original Positions (Op1, Op2, Op3, etc.) [see below] for the purpose of allowing I-REC to find its way back to the correct Original Position (Op1, Op2, Op3, etc.) after input by I-GIV of Entry Positions (P1, P2, P3, etc.) [see below] on an Entry Form (IEF, SEF) [see below] without allowing others to find its way back to the correct Original Position (Op1, Op2, Op3, etc.).

ID or Identity, which identifies an I-GIV or I-REC to the other party. ID can exist as many different forms of authorization, such as bank card numbers (FIG. 1-4), CVV2 codes, access codes such as MasterCardSecureCode® mfl., social security numbers, user names, passwords, PIN codes, access levels, military or other secret concepts, or identity codes used one or more times for online banking, for instance.

Information is the mass of characters transferred or meant to be transferred from I-GIV to I-REC in any given instance. Information can also be a stored mass of characters. ID is information, but information is not always an ID. Information is part of an Original Message (0). [see below]
1. Information can have any form, see for example FIG. 1 (IEF) and FIG. 3 (SEF).
2. Information may be formatted in accordance with a previous internal agreement between I-GIV and I-REC.

I-GIV—Information Giver

I-GIV may be:

1. A physical person
2. A device
3. Only one I-GIV
4. I-GIV one time and I-REC the following time
5. Alternately first I-GIV and then I-REC in a regular pattern of such alternation (interactivity in one or more steps/sessions),
6. Alternately first I-GIV and then I-REC in an irregular pattern of such alternation (interactivity in one or more steps/“Sessions” [see below]),
7. More than one I-GIV
8. Another I-GIV during a session
9. An Internet bank account holder or Internet bank
10. Someone who makes purchases using a bank card or other ID on the Internet
11. Another actor who reroutes an Original Message from an I-GIV (FIG. 6-8) (FIG. 1-4)

I-REC=Information Recipient

I-REC may be:

1. A physical person
2. A device
3. Only one I-REC
4. I-REC one time and I-GIV the following time
5. Alternately first I-REC and then I-GIV in a regular pattern of such alternation (interactivity in one or more steps/sessions),
6. Alternately first I-REC and then I-GIV in an irregular pattern of such alternation (interactivity in one or more steps/sessions),
7. More than one I-REC
8. Another I-REC during a session
9. An Internet bank account holder or Internet bank
10. An Internet webshop accepting bank cards or other ID for purchase
11. Another actor who reroutes an Original Message from an I-REC (FIG. 6-8) (FIG. 1-4)

Entry is the keying in/registration of information through a PC keyboard, touch screen or other data entry method, for transfer to I-REC. Entry may take place manually, automatically, or by means of a mixture of both.

Entry Form: A question form generated by I-REC that can have any appearance, and which is presented to I-GIV for use in Entering Information. (FIG. 1 “IEF”, FIG. 3 “SEF”). There are two types of entry forms:
a) Initial Entry Form (IEF) is the Form window displayed by first I-REC on I-GIV's screen in the form of data entry windows, some of which are open, and others of which are closed and which may not be possible to be filled in, and are therefore, for instance, marked black.
b) Subsequent Entry Form (SEF) is the Form window displayed by first or subsequent I-REC on I-GIV's screen in the shape of windows, some of which are open, and others which are closed and which normally cannot be filled in, and are therefore, for example, marked black. SEF can be one of several SEFs in a series of subsequent deliveries of parts of Information by I-GIV to I-REC or only the last Entry Form of a SEF with the remaining fields to be completed of the Original Message. The sum of open entry windows in total SEF:s is at most the number (remaining after IEF) of open windows for the entry of information in response to an Original Message, O, [see below], or ID [see below].

Entry Position The entry form consists of Entry Windows [see below for definition] with Entry of at least one character at each such position/window. (Entry Positions PI,P2,P3, etc.). Entry can take place in Entry Windows ( R1,R2,R3, etc.) in accordance with FIG. 1, 3, and 7. Entry Positions can proceed in keeping with the logical sequence of the Original Message (O) in the Initial Entry Form (IEF) and the Subsequent Entry Form (SEF) (FIG. 1-2). It can also be specified in advance that Entry Positions be Entered in a scrambled order generated by so called “Labels” (FIG. 6-8) through a procedure controlled by I-REC, so that I-REC can later reassemble the positions (FIG. 6) in a secure setting by knowing the location of the Labels. The entry windows can thus vary from the anticipated Entry Position (FIG. 6). In order to keep track of this, Entry Positions need to have the unique Labels. Schematically, this can be done as follows:

### EXAMPLE

Initial Entry Form, IEF, FIG. 6

Original Position Op14, Entry Position P1, Label E4
   Second Entry Form, SEF, FIG. 7
Original Position Op7, Entry Position P7, Label E1
   Third Entry Form. SEF. FIG. 8
Original Position Op13, Entry Position 17, Label E12

The relationships between them are exemplified in FIG. 6-8.

Entry Window (Closed or Open) In certain cases the Positions are visible as Entry Windows. In such cases, the number of Entry Windows may correspond to the number of characters, for instance, in an ID or in an Information. Only certain Entry Windows may be open for Entry and are called “Open” whereas other Entry Windows may be closed to Entry and are called “Closed” and are then either black or marked in another way in order to be opened later for entry in one or more Subsequent Entry Forms [SEFs]. Closed Entry Windows may contain bogus information hidden from the user aiming to mislead malicious software “Spyware” logging all information on the screen.

Interactivity Alternating coordination and data exchange between I-GIV and I-REC in a running or random design and form. Interactivity may occur in at least the initial phase of Authentication.

Internet banking Online service is provided by banks in order to make the use of banking services easier.

IP Number (Internal Protocol No.) A unique multi-digit character address (a type of “street address”); every device connected to the Internet is required in advance to have provided its identification/location to the Internet itself in order to make use of its services. In the present document, IP is used instead of the full name IP Number. IP is a place where criminals can go to eavesdrop and copy data transmission. I-GIV and/or I-REC may have more than one IP. IP can exist in fixed or dynamic form. IP is assigned under a domain (a unique proper name chosen—openly or as an Alias).

Medium The forum—fixed, optic, wireless or else—over which the session takes place.

MPOP Mobile Internet Phone/cell phone Operating system. For mobile Internet phones describing the standard operating system software of the mobile phone apparatus.

PC A computer of any make as Macintosh, PC, LapTop or any other kind of computerized body.

Pharming Is a modern piece of Spyware technology that “cultivates its prey” inside a PC.

Phishing A criminal method for tricking an I-GIV into giving up Information, such as an ID, CVV2 code, login codes, text, etc. to a bogus Attraction Site or email belonging to a criminal I-REC.

Private Keys are code keys exchanged in advance between authorized parties in a way that is more secure than sending them to each other digitally. In the invention at hand, there are private keys in the SIM card and at I-REC at the opposite end point. When a transmission occurs without private keys inside the data packages, no “digital fellowship” of “flag” is required between the data packets that constitute the transmission, such that no wire tap will be able to find all the parts of the Original Message and successfully decrypt/decipher them. The present invention normally makes use of private keys, sole.

Public Keys are the opposite. These code keys are visible to all since they are included in the transmission itself. When data is sent with public keys, there has to be a “digital fellowship” between the various data packets that constitute other transmissions or the packets cannot be located and assembled by even the true I-REC. This fellowship exists in the form of what are referred to as flags that aid in locating the packets to the Original Message and its final assemblage, which wire tap is also able to do. The invention at hand does not make use of public keys.

O=Original Message All characters in the original mass of characters that has been transferred from I-GIV to I-REC over a number of sessions across which the Information is split. (FIG. 1, 3, 5, 7, marked “O”)

OP=Original Position One of the unique character positions found in the Original Message. Op1, Op2, Op3, etc. FIG. 7.

PC-Zombies are PCs that have fallen victim to invasive surreptitious software that can be controlled remotely by criminals in order to carry out all manner of criminal tasks.

Proxy is a (criminal) function during data communication wherein I-GIV is forcibly and unwittingly connected to I-REC via an intermediate data server—a proxy server—instead of directly to the intended IP. This is called “man-in-the-middle.

Rootkits are advanced carriers of spy software and are considered to fall under the category of Pharming. They lie deep in the PC's system, and some are impossible to detect less to remove once infestation has occurred. Rootkits are considered to constitute the greatest threat to the online monetary system. Criminal groups sell or rent Rootkits to commit fraud, e.g. at http://www.bebits.com/app/2469.

Others produce Rootkits in order to protect criminals against antivirus programs, such as “Hacker Defender.” Rootkits are the greatest danger for InternetBanking, ecommerce and military and the protection against them is poor or lacking.

Session. Is a remote connection over which information is to be transmitted between at least one I-GIV and one I-REC. Sessions can occur at random and are therefore entirely unpredictable for Spyware programs, which prevents them from analyzing characters and determining that they belong to the Original Message. FIG. 1-2 is Session 1. FIG. 3-4 is a subsequent Session, or, in the simplest of cases, a final Session for the Original Message. FIG. 6-7 is a Session example in a more complex application.

SIM Card. A unique card with a processor “chip card”, such as a cell phone card or a separate SmartCard specifically for the Device, see definition above, or a standardized bank card with a data chip that contains a specially encoded and encrypted soft ware module that serves the purpose of the invention. SIM card is the future format of the current Standard Magnetic Strip Card, SMSC.

Spyware is a data virus such as “keystroke loggers,”, screen dump loggers,” data storage loggers” “Rootkits,” etc. whose purpose is to infiltrate PCs and root themselves in them in order eavesdrop locally and collect IDs, Information, texts and/or entire Original Messages, which are then forwarded to a remote criminal mother server (unknown to others) where the information gathered is fraudulently exploited. In FIG. 2, 4, 5 and FIG. 7, the Information which was entered, and which was duly intercepted by spying both in I-REC and by a Spyware program in I-GIV's PC, is shown. There are many terms used to describe Spyware. Other terms used are “malicious code, scumware, crimeware,” etc.

SMSC—Standard Magnetic Strip Card—the current kind of plastic cards issued by banks. (Compared to SIM Card)

VPN-Tunnel Virtual Private Network Tunnel. This provides confidentiality, integrity, and origin authentication peer-to-peer.

### TODAY'S PROBLEMS AND BENEFITS OF THE INVENTION

Theft of identities and other data is an ever increasing activity that affects both the Internet and other forms of data transfer. These days, it takes place automatically. In part, people are fooled by phishing, but another aspect is that programs can infiltrate a normal personal PC to steal IDs and other information in a variety of ways. In addition to this, the Internet is regularly wire tapped, encrypted transmissions attract unwanted visitors and encrypted information can often be decrypted these days (Cryptogram, “SHA-1 cracked” January 2005).

The annual cost of identity theft in the USA alone is calculated to be in the tens of billions of dollars, and even if customers are compensated when their accounts are emptied, ID theft can cause lifelong disruption by destroying credit ratings and compelling victims to pay back credit card charges and bank loans taken out by other people in the victims' names. ID theft is the fastest growing crime threatening the Trust in the online financial services with huge impact to Homeland.

In recent years, identity theft has become one of the great threats to both individual and societal resources, and is able to continue apace because no one is able to stop ID theft in homes not seldom a result of a poor online login and authentication system that exploits the users to Spywares. Ongoing court disputes tell us that consumers do no longer accept this exploitation requiring a better protection when using the online services. Legal actions to financial actors will increase. We are facing just the commencement.

Encrypted web sites/transmissions are of no help if IDs have been stolen already at the PC keyboard or screen before a transaction occurs. Furthermore, encryption is of even less value when customers have been lured to give out login codes long before. These Spyware programs are so advanced they are becoming ever more difficult to detect and to get rid of; their sheer numbers and destructive ability are increasing by the month, proliferating by the thousands. Botnets grow in number by 100,000 a month, with the largest Botnet found to date consisting of 1.5 million PC zombies. In April 2006, the Russian Minister of the Interior called for international cooperation because, in his opinion, CyberCrime is now more dangerous than weapons of mass destruction.

Certain Spyware programs are designed in such a way as to prevent their own obliteration, with others able to repair themselves after cleanup. The most advanced forms can even instruct PCs to falsely notify users that cleanup has been executed successfully. Other programs attack the antivirus software itself. 80% of all PC users in the USA consider their PCs to be virus-free, though 90% of all PCs have been proven to be infected with PC viruses. In Europe the figure is 25% of all PCs. Infection is often invisible, and cannot be fought. As of today, there is not a single effective shield against this accelerating societal threat within the field of the present invention. Fear is on the rise, and trust in the monetary system's services on the Internet is in sharp decline (Gartner September 2005, APACS 2006).

Spyware serves to enable proxy connections, i.e. enables the theft of transmitted information, which can then be sold and/or to redirect ongoing legal communication between I-GIV and I-REC (i.e. an Internet bank) in order to skim or empty entire accounts, and/or to steal identities from I-GIV for later use and/or to eliminate commercial competition in other ways, i.e. by tarnishing the reputations of good brands and/or inflicting damage through terror or some other form of criminal intent. Neither I-GIV nor I-REC may know that an intermediate server is in control of the connection established by the authorized parties, since the Information can be displayed just as validly by proxy and the so called end-sum checkout (the sum of each of the characters in a certain transmission approved by real account holder to bank) can be compromised by a lurking proxy in between them.

Spyware also aims to take over PCs and remotely control PC-zombies in order to undertake criminal enterprises. The immense power of a Botnet was shown in Sweden in May 2006 when somebody started a Botnet attack against the server of the Central Police and of the Swedish Secret Service in turn making them collapse and a few days thereafter the Swedish Government server systems were overloaded and went down. Botnets must be considered as the worst threat of 2006-2007. If put into mass operations in the Online financial systems this will become a night mare to all of us. The common benefit of the present invention cannot be over estimated.

Spyware is able to detect and select keystrokes for all information and IDs. See FIG. 1, 3, 5, and 7. Spyware is also able to scan everything that is written and which appears on the screen (“screen dump loggers”). In addition, these programs can locate and steal previously saved information and IDs in the PC's archive.

Spyware is also able to select and read other forms of data entry than those that take place manually via a keyboard, such as fully automated systems and processes for resolving authorization rights, authentications, identifications or other methods of information exchange. The Spyware programs are statically designed and are not flexible, a property which would be needed to be able to analyze interactive forms of information exchange or the Device to which the invention applies. This large weakness in Spyware programs thus constitutes a reason for the present invention, which for them will create entirely unexpected combined changes in anticipated data entry and information transmission methods, etc. In this way, the invention's combination method presents the first opportunity to put an end, from the beginning, to current forms of criminal damage by Spyware and the growing threats posed by the tens of thousands of various Spyware programs on the Internet.

The fact that this type of PC virus constitutes a threat to society is demonstrated by the analyst company Gartner, which reports that ever more Britons have entirely ceased to use Internet banking and to execute Internet shopping with bank cards, and that far more than half the population has grown generally more dubious about the overall viability of the Internet as a financial tool. The fact that 57% of all Americans abandon the Internet shopping carts they had wanted to buy without checking out should serve as a warning. Several other similar statistics are available in many countries regarding e-commerce. Neither the banking system nor retailers are in a position to be able to return to the era of check books and heaps of cash without causing profound societal disturbances and, in the worst case scenario—as is being predicted by some experts today—stock market crashes and a new Great Depression. An invention able to solve a great part of the above dilemma would thus be of enormous social utility, and would attract many imitators.

Even if e-commerce and Internet banking appear to be the most common applications that would be protected by the invention, in its core the method is equally well suited to protecting other highly coveted information, such as banks' SWIFT codes and reference numbers, military codes, carelessly handled encryption codes, geographical position transmissions, project identities, etc., with clearly established search information; the method could also be effective against industrial espionage.

The two most common forms of transfer of coveted financial information via the Internet is e-commerce and Internet banking. We will concentrate on describing the invention's functionality in these two cases.

In a primary embodiment, EMB 1, of the present invention, we demonstrate its capabilities using a buyer who intends to purchase a product or a service on the Internet using a bank card so called card-not-present, CNP.

In a second, more complex embodiment, EMB 2, of the invention, we demonstrate its capabilities using a bank customer who wants to make banking transactions on the Internet.

### THE PURPOSES OF THE INVENTION, AND A FUNCTIONAL DESCRIPTION

One of the purposes of the invention is to prevent Spyware from using locally intercepted information to link one's personal information to an Original Message, as well as from either understanding the meaning of an entry, or understanding it correctly, or how the Information is transmitted not even when. This confusion—added to that the Spyware is statically designed and is not flexible—eliminates the correct analysis of the scanned information and the intended transfer of sensitive information to a remote criminal mother server will contain something else than the Original Message. This protects the potential victim against a devastating ID theft.

In addition to this, the invention eliminates Phishing, against which there is no protection today.

In the description of the “Device” below, the term refers to the combination of the Device and the SIM card, if nothing to the contrary is specified—and in each instance only in their applicable parts.

The EMB 1—The Manual Function of the Entry Form

In this embodiment of the invention, manual Entry in the Entry Form provided by the Internet web shop, I-REC, is performed by the customer I-GIV pursuant to FIG. 1-8. This application is best suited to e-commerce and others and not for Internet Banking.

The invention's combination method, consisting partially of functions with Entry Windows FIG. 1, 3, 5, and 7 (R1, R2, R3, etc.) and Entry Positions, respectively (P1, P2, P3, etc.), and partially of the alternating exchange of Information (FIG. 1, 3, IEF, SEF), protects against unauthorized wire tap and thus eliminates the conditions needed for a “Proxy” connection by attacking and utterly disrupting what such wire tap relies on, i.e. the Spyware programs grouped under the heading Pharming.

Thus under more complex conditions the invention can protect long text passages against Spyware programs by adding several Entry Forms to several alternating Interactivities and/or Sessions between I-GIV and I-REC in a mass session scenario. This is a level of security that currently does not exist.

In its even more complex application, the invention is enabled by means of repeated, alternating Sessions for transmission of the Original Message in which I-GIV turns into the role of I-REC, only to revert to being I-GIV again, and so on. (Session 1, FIG. 1, Session 2, FIG. 2, etc.), all while the randomly generated Entry Windows (R1, R2, R3, etc and/or Entry Positions P1, P2, P3, etc.) add to the difficulty of analyzing the unexpectedly alternating Session format during the data transfer process. A potential Spyware program's analysis of such a process will be entirely worthless.

To Exemplify:

The Information into I-REC's system is complete (FIG. 5), returning a value of 123456787654321, whereas the Spyware program's log is incomplete (FIG. 2 and FIG. 5), returning a value of 134688432 for the First Entry Form “IEF”; the Spyware's log of the Subsequent Entry Form “SEF” is just as incomplete, returning a value of 2577651 (FIG. 4 and FIG. 5). In addition, from this it emerges that for a Spyware program created in order to mine the 16 digits of, for example, a bank card, the results of FIG. 2 and 4 will return 9 digits from the Initial Entry Form (IEF) and 7 digits from the second (SEF)=1346884322577651 i.e. 16 digits in all incorrect as the credit card number was 123456787654321. In addition to this, these are two separate sessions that are not digitally related in turn not easy to an already designed and non-flexible Spyware to analyse them to be in the same credit card when nothing according to the Spyware design matches. The dedicated working instruction of the virus fails, since the virus does not find When, Where or How to perform its criminal task. The EMB 1 is a kind of encryption.

The EMB 2—The Function of the Device and SIM Card in Alliance

Even though it will not be fully expressed in the following embodiment and different applications therein the function of the EMB 2 enables usage for as well additional purposes as Internet banks, military purposes, e-commerce and for any other application where strong authentication and automated login is required i.e. not limited to the expressed area of usage.

This embodiment, EMB 2, uses a “digital forms” IEF:s and SEF:s containing the Information which will be 1 encrypted in a far stronger way including several interactive sessions and likewise exchange of the I-GIV and I-REC positions between a Device at the bank customer's end (original I-GIV) and the bank server end (original I-REC) instead of a webshop end point.

An Internet banking customer receives a registered regular mail from the bank including a Device, as well as a SIM card, sent separately. The Device is about the size of a PDA, and has a full display but no keypad.

The customer connects the Device to his PC's USB port via a cable or wirelessly. The PC supplies power to the Device that enables insert of the SIM card in a SIM card holder inside the Device.

The customer then connects his existing keyboard and mouse to the Device . Those with impaired vision or otherwise disabled or aged can connect a touch screen to the Device. The Device is as well equipped with a port for a separate larger PC screen as an option.

The SIM card is a “hardware code,” i.e. no password is required of the customer, even though in an additional application the Device could be equipped with this extra security feature. With no password to hide, protect and to recall, the user friendliness improves as people are very tired with passwords and even Microsoft® VD Bill Gates predicts that passwords (PWDs) have no place in the modern Society.

The customer then inserts the SIM card into the Device and a fully automated process takes place. For the very first time a handshake procedure is initiated between the Device and the SIM card. After this, the Internet banking module in the SIM card/SmartCard only works together with this specific Device, which vice versa works with this specific SIM card, solely. The only exceptions to this rule are in the event of an authorized SIM card or Device replacement, as well as when several authorized users are allowed to use the same authentication system.

As soon as power supply from the PC to the Device is present, the SIM card can be inserted into the built into card holder—otherwise the SIM card cannot be inserted into the Device. Inside the Device there is a mechanical stop that automatically is released when the Device is connected to PC electric power supply enabling the SIM card to be inserted. As soon as the power is gone i.e. by disconnecting the Device from the PC USB port, the stop is activated and the SIM card is ejected and cannot be inserted again prior to electric power to the Device. This is to enhance the security as nobody can store the SIM card inside the Device by convenience when bringing it in his pocket to the Automatic Teller Machine (ATM), to the supermarkets, to the summer house, job or to holidays. As the SIM card is ejected from the Device and cannot again be inserted into the passive Device, the customer has to put the SIM card somewhere else and it will be safely apart from the Device, when in passive mode, securing from robbery and burglary, carelessness with the Device and the SIM card, etc. moments of risks enabling unauthorized people to get their hands on both the SIM card and the Device at the same time. Pick pockets don't plunder more than one pocket, so either the Device or the SIM card is lost—both are not.

Every time the SIM card is inserted into the Device, it will then instruct the PC to become its client, i.e. the PC's operating system will serve only the Device's operating system and will perform only a highly limited set of tasks. A preferable arrangement would provide for two separate operating systems, where the Device's operating system could be an industrial operating system with extremely few functions (vulnerabilities) in order to forestall infiltration by PC viruses from the proximate infected PC environment to Device. The PC client's tasks are to supply the Device with power, printer functionality, broadband access and Device encrypted data storage for the Device's transaction data. The PC's screen is not used. The Device has its own display or a separate screen connected therein.

As soon as the SIM card is inserted, Authentication begins without the customer having to do anything. This occurs through cooperation between the SIM card and the Device, which leads to the Device ordering the web browser on the client PC to connect to an IP randomly chosen by the Device/SIM card from the SIM card's IP database. This database consists of several IP whereof which everyone is an IP to the Bank endpoint server inside the Bank Perimeter 60 [see down]

Next, a connection to a bank server or an e-commerce portal is set up. In EMB 2 (with a Device), an interactive Authentication process then takes place with alternating connection and exchange of authorization codes between the Device and the server. Regardless of the direction in which the codes are sent, they are encrypted in a form that is not based on the encryption protocols destroyed in 2004 in accordance with the Secure Socket Layer (SSL), described above. The Device and the server use an entirely new encryption method based on the private keys pre-loaded into the SIM card and the server and could favourably be based on the encryption protocol and IEF and SEF forms described in the “EMB 1” for e-commerce [see above ]. No “public keys” are used. Neither in the EMB 2 there is no “digital fellowship” between the data packets transmitted in the Sessions of the interactive process.

This means that an eavesdrop will not have enough information to support his decryption process by the wire tap. The process featured in the invention requires more than one server at the Internet bank, e-commerce companies or other actor. These servers are servers equipped to send and receive message and message parts in a to the Device unique and dedicated way in a multi-session process.

The format of the transmission between the Device and the bank does not comply with the format required by the bank. For this reason the servers must be implemented inside the bank Perimeter 60 to reformat the data from Device into a suitable and already accepted format that the platform of the bank data system requires for upholding the service. The invention according to EMB 2 becomes “platform independent.” This is an analogue to the EMB 1 which is platform independent too, fitting into the webshop server system accepting the format entered by customer. The software in the bank servers is based on a duplicate of the software in the Device with extension to fit the complex features of EMB 2. The meaning of using several bank servers in one of the applications of EMB 2 is that the IP number ordered for connection by the Device, will be altered many times to confuse Spyware which are designed to save the one and only bank login IP number generally used by competing methods. Randomly used IP numbers are replaced without warning in an interactive login procedure with connected, disconnected, connected etc. lines in a flow between the Device and the bank servers. This interactivity of connections during the login procedure will make it useless to criminals to set up a man-in-the-middle scenario as the next IP number in the EMB 2 application will never be the same and Spywares fail. Moreover, the SIM card contains a separate list of approved login codes to be sent to the bank during authentication procedure and likewise the SIM card contains a further separate code list with authentication codes expected to be reverted from the bank server to authenticate the bank to the Device. The bank servers contain the corresponding lists in order to firstly identify into which bank servers (IP number list) the information is arriving from the Device and secondly the list for authentication of the Device (access code list) as well used for the bank server to authenticate itself to the Device. The flow between the Device and the bank servers will be a mix of true and false data encrypted with private keys and hash with no possibilities for Spyware and/or eavesdropping to comprehend the bypassing string of unknown characters. An additional application is that alarm is trigged by the Device in real time in case of criminal attempts to re-route to bogus bank web sites during the process. This secures a strong protection component against both keystroke, screen dumping loggers, wire tap and phishing bank web sites.

In one application of the present invention, there is a protocol inside the Device that randomly generates open and closed Entry Windows into which information to be sent is entered. In another application, I-REC sends a requirement specification to the Device, which “fills in” the empty Entry Windows in the intended way.

When the Authentication phase is complete, the customer can start using the bank's/website's services by interacting with them using this PC's keyboard and mouse, which are now connected to the Device instead.

All data transfer takes place in the same way: Encrypted data is sent from the Device (I-GIV) to the client PC, then out to the Internet and to I-REC, where analysis is performed; repeat. This process can most closely be described as what is referred to as a so called “VPN tunnel.” Once the transactions are complete, the customer can store them in the client PC by creating a folder there. The Device transfers desired transaction data to this folder in encrypted form with keys that only the Device recognizes. In such a way, the client can work with his accounts Offline as well in case of inserting the SIM card into Device and choose OFFLINe mode. This enables him to fetch stored encrypted files from the designed folder in PC for any Offline use.

When the transactions are finished, the SIM Card is still inserted in the Device and the PC is still in Client mode. In order to write e-mails, browse the Internet, print letters, play games, work Offline etc. with the PC, customer needs to put PC into “Standard mode” again and release PC from Client mode. This can be made by ejecting the SIM card, sole. SIM card is ejected from the Device, at which point its control of the client PC ceases; the PC then returns to its Standard mode with common functions with all its services. The keyboard/mouse, however, remain plugged into the Device. This gives customer an extra protection against at least keystroke loggers when writing letters and emails, as loggers cannot scan any event outside the PC, moreover, once the keyboard and mouse are moved from PC to Device it's user friendly to let them stay in position.

Because the SIM card is absent, there is now direct communication between the keyboard/mouse and PC, via the Device, which is on standby until the time comes to log on to a bank site or e-commerce portal again, at which point the SIM card is inserted into the Device anew to activate the security functions.

If the customer wants to bring the Device along when he travels, he can unplug the USB cable from the PC. The keyboard and mouse can often stay at home, i.e. they can be removed from the Device, which can then be placed in a pocket, and which is useless without its own SIM card.

In case a bogus bank email arrives or coincidentially customer browses the Internet and gets rerouted to a fake bank web site attempting to lure codes and others from the customer, he cannot make any mistake as he doesn't know any codes of importance to his bank account to give out to phisher.

In event the Device is unvoluntarily rerouted to a fake bank web site during authentication process to the true bank, the fake bank web site cannot authenticate itself to the Device. A connection to a pre set suitable Alarm IP number will be promptly opened by the Device to discretely inform about the attempt for legal actions in real time which is easier to execute in real time than long time thereafter as is This feature is not yet invented and heavily gaining.

By Means of the Invention:
1. The customer cannot give out authorization codes by mistake as a result of Phishing, since the customer does not know the codes in the SIM card.
2. Spyware programs cannot log keystrokes, since they take place outside the infected PC environment.
3. Spyware programs cannot interpret the codes and other data sent from the Device to I-REC and in revert by the later, since all information is already encrypted outside the infected PC environment.
4. Spyware programs cannot analyze the encryption that passes through their midst in the PC, since the data is coded with entirely new and shifting encryption models using private keys.
5. Spyware programs cannot perform screen captures of the PC screen, since no data is written anywhere on the PC; data merely passes through the PC.
6. Spyware cannot effectively scan folders in PC to steal data being encrypted by the Device located outside infected PC environment
7. Encryption will not be made with cryptographic protocols already compromised.
8. Real time alarm discloses any attempt of phishing with fake bank web sites on site.
9. Nobody is able to successfully perform wire tapping or decrypt of data, since the transmissions are interactive, with multi-sessions, and neither contain public keys, nor exhibit digital fellowship between packets.
10. Since the PC cannot be used in the customary way (mail, surfing, calculations or games) when the SIM card is in the Device, security is dramatically increased in the event of a break-in and during transportation, since the customer is forced to remove the SIM card from the Device and will keep the card in his wallet rather than leave it lying about.
11. When power to the Device is cut, the SIM card is ejected and can no longer be placed in the Device. A physical SIM card block is actuated in the event of a power outage. This increases security in the event of pick pocketing, since the customer will normally place the SIM card in his wallet along with his other plastic cards, and keep the Device in another pocket.
12. In addition, the customer receives good protection against Spyware programs in his PC in normal operation (Standard mode) as well (e-mail, letters and other important written information) in that data entry can still take place outside the infected PC environment because both mouse and keyboard remain connected to the Device that just leads the signals into the PC in Standard mode.

In another application of EMB 2, there are no account numbers or customer numbers at all stored anywhere other than the bank, e-commerce companies, etc. All accounts are called “1, 2, 3, 4, etc.” or are referred to by names such as “Home, food account, loan, etc.” This further enhances security, since no real account numbers are kept by the customer. Actually, why should he remember long account numbers risking to lose them by writing them into a laptop or mobile device or perhaps on more risky places. In an additional application of EMB 2 using mobile Internet (telephones)—herein called “mobile phone”—the Device is implemented inside the telephone, so that when a caller uses the phone for Internet banking or e-commerce, an operating system other than the infected one will control the telephone.

A mobile phone is operated by a Mobile Internet Phone/cell phone Operating system (MPOP) serving the functions/features of the mobile phone. In an additional application of EMB 2 the function of the Device could be built into a mobile phone in form of an additional software—a Device Operating System (DOP)—serving the function of the invention, sole. When shifting over to EMB 2 in the mobile phone, the MPOP will be switched/adapted to a client function to the DOP likewise earlier described for an operating PCsystem to become a client to the Device. The features of the mobile phone will become likewise reduced to e.g. power supply, Internet access, data storage and printing functions, accordingly. The DOP will automatically login and the database of IP numbers and access codes is likewise stored on a SIM card. The shifting over from MPOP to DOP can be made with keystroke/s and/or a PIN code activating the specific second SIM card inserted in the mobile phone in a second built into card holder.

In an even more advanced application of the EMB 2 the already inserted and active mobile phone smart card itself could be equipped with a certain Internet Bank module “Internet bank mode” apart from the Standard mode and MPOP of the mobile phone. This would exclude a special SIM card and make the mobile phone itself even better equipped. The mobile phone card then must be designed under the control by the bank to uphold the secrets of the IP numbers and login code lists. The security will be less than the former application, however, a PIN code or a biometric system could be as good a protection against criminal use of the mobile phone and/or an immediate stop of the use from another and perhaps distant phone sending an Terminating-SMS to the lost mobile phone or SIM card that erases it all as soon as the loss is detected. In another advanced application of EMB 2, the Device can be used as a hardware shield against skimming in ATM environments. This can be compared to a “hardware locker,” which is a radical new security protection for ATM machines.

The problem today is, on one hand, that fake bank cards gained through skimming and data infringement can be used in ATM-type cash withdrawal machines; and on the other that ATM machines today are subjected to false fronts that use cameras to steal PIN numbers and passwords when inserted and passing by the criminal reader into the ATM, and which read bank cards as they are passed through the ATM front in order to use their information in the illegal manufacture of bank cards. Moreover, data theft of hacking into databases is a well known problem. In 2005 about 40 mln credit card numbers and PINs were stolen in an Arizona intrusion. A large amount of credit cards are now around the globe. Supermarkets and ATMs are the prime targets to these fraudsters.

In this application of EMB 2, it is impossible to a fraudster to use any kind of skimmed cards; he can't even use a stolen smart card as her lacks the Device and vice versa. The ATM-application of EMB 2 will terminate each ATM theft attempt.

Another flaw with ATM is that most ATMs don't encrypt transmissions which supports wire tap. The EMB 2 on the other hand always encrypts data prior to transmission and supports the bank. The ATM- application of EMB 2 will make worthless each scan of unprotected data from & to ATMs.

A third flaw is that the magnetic strip on the back of a standard plastic card, an SMSC, includes information built into the chip if a chip card. This is to facilitate the use. However, this makes it possible to analyze the magnetic strip to get into the chip. The EMB 2 application of the invention prevents from this if a bankcard is used requiring a certain sealed module in the chip that doesn't exist in the magnetic strip of the card backside. This enables a card holder to use his chip card in ATMs and in supermarkets irrespectively of bringing his Device with him there as the sealed module is able to connect for login to the bank server for the stronger authentication feature of the invention giving access to the bank directly and not via credit card companies in order to save costs. In the supermarket it's however required a special reader enabling usage of both card and card/Device at cashiers'. The invention enables this multi-feature use to a smooth start of the use of the invention as replacement of SMSC to chip cards takes time. (See furthermore down).

Moreover, the very new step by fraudsters is to break into supermarkets in order to install malicious software in local servers to scan customers' credit card numbers and PIN codes from tills at cashiers' line during the route to a remote checkout prior to encryption for the transmission. The supermarket feature of the application of EMB 2 eliminates this new criminal method the sensitive data is encrypted already when passing the malicious software wherever installed at the supermarket as all data becomes encrypted already inside the Device itself at cashier's reader.

Furthermore, each time a supermarket customer swipes his card in the till, he gives away his Identity without prior login and authentication and in no real time and disconnected after swiping which is made by the supermarket itself upholding the real time in its later phase of process.

The supermarket applications of the invention on the contrary requires a real time login from the Device to the bank server and full two-ends authentication and no disconnection as described above which substantially enhances the security as no sensitive data is given away until procedure is accepted by both parties. The role of the supermarket won't any longer be the Authenticator but the carrier of already encrypted authentication, sole. The supermarket application of the invention is feasible for any kind of shop accepting plastic cards for purchase and skimming will be eliminated.

It will take a very long time to exchange the SMSCs to the more expensive chip based plastic cards. Meanwhile The SMSCs are continously printed and given out by banks. An application of EMB 2 is to meanwhile use the Device together with a SMSC. This opens several new applications to the invention. the SMSC. The software of the magnetic strip will be split into 2 parts (partitions). Part 1 is for the standard use and Part 2 for Device use of the invention. Part 1 is used for ATMs and swipes when Device not present. Part 2 requires the Device. Part 2 is encrypted in the way of understanding by Device as described above. When a customer docks his Device at a supermarket with Device-readers, the SMSC is already inserted into Device as described above and automated login even when a SMSC card used. To enhance security for stolen SMSCs a master PIN code for Part 2 of the magnetic strip can be required. p The ATM- Procedure:
13. The customer inserts his card into the ATM
14. On the screen (which cannot be reached by criminals), the customer can see how the card is moving inside the ATM to alarm customer if stopped by a bogus ATM front.
15. On its way into the ATM, the card cannot be read by an outside device, since the card requires simultanity with its approved Device in order for the information to be accessed.
16. That simultanity takes place far inside the ATM,
17. Once the card reaches its inner docking station and having been approved by the docking station, a small slot opens on the ATM-machine.
18. The customer inserts the Device itself into the slot and can see on the screen how the Device in turn is shunted to its own docking station without reach by fraudsters.
19. There, the SIM card and the Device docked into the respective docking station are put in contact with one another, and log onto the bank's server in the manner described above.
20. All the customer has to do is enter how much money he wants to withdraw and press Enter. Password not necessary but can be added to enhance security. If PWD shot by fraudulent camera picture of PIN is worthless without the SIM card and the Device anyhow.

This Application of EMB 2 Eliminates All Threats of ATM Fraud Relying on:
1. False ATM fronts, since these are unable to read the SIM card
2. Spy cameras in the false ATM front, or mobile phone cameras held over the customer's shoulder, since no codes are entered by the customer, and, in the cases where the Device requires a password, knowledge of this alone will do criminals no good.
3. Card alone is useless—if not a special sealed Internet mode imprinted (above)
4. Device alone is useless
5. Skimmed cards useless without access to Device requiring a certain SIM card
6. Encryption takes place already by the Device and the Card inside the ATM which supports the banking system as ATMs are commonly not encrypting transmissions from machine to bank back office for checkout. Each such transmission is open for wire tapping as easy as to wire tap a telephone call.
7. The ATM application of the invention affords protection against SIM card theft, since if the card is swallowed by the false ATM front, this can be seen on the screen, and no slot will be opened for the Device.
8. Moreover, a lost SIM card or a lost Device can be immediately blocked by a phonecall to the security department, moreover, the invention enables a customer to send an SMS to a certain number to block it instantly and the ATM will swallow both card or Device.
9. The supermarket of the invention afford protection against flaws by installation of malicious software in supermarket backoffice servers to scan identities prior to encryption to Internet transmission for remote checkout. In the present invention the data will be encrypted already in Device at cashier's of no criminal use and the real time feature protects account holder against identity theft during the transmission to remote checkout compared to the insecure present solution with no real time control of the transmission of the sensitive data by owner.
10. Skimmed new printed plastic cards cannot be used by criminals as no real time authentication can be made if the SMSC Part 2 module is not inserted into Device which fraudster does not possess.

### DESCRIPTION OF THE DRAWINGS FOR THE PRIMARY EMBODIMENT, EMB 1.

FIG. 1: Randomly generated (by I-REC in an initial Entry Form (IEF)) Entry Windows (R1, R2, R3, etc.), along with corresponding randomly generated Closed Entry Windows (S1, S2, S3, etc.) as an initial phase in I-GIV's Entry of Original Information (O);

FIG. 2: Result after the initial Entry, to be transmitted to I-REC regardless of whether Spyware programs are eavesdropping or not;

FIG. 3: Randomly generated (by I-REC in a subsequent or final Entry Form (SEF)) Entry Windows (R1, R2, R3, etc.), along with corresponding randomly generated Closed Entry Windows (S1, S2, S3, etc.) as part of/the next phase in I-GIV's Entry of Original Information (O);

FIG. 4: Result after the subsequent Entry, to be transmitted to I-REC regardless of whether Spyware programs are eavesdropping or not;

FIG. 5: Final result. The character row displays a result that I-REC can analyze to arrive at a portion of the Original Message (O), in this case the entire Identity (ID). The character rows beneath show the Spyware programs' two separate analyses of what was Entered and what was transmitted;

FIG. 6: The Entry application developed pursuant to FIG. 1 with an initial Entry Form with fixed Entry Positions (P1, P2, P3, etc.), though with random Label names (E4, E15, E5, etc.)

FIG. 7: The second Entry Form which has new, shuffled Label names (E10, E6, E18, etc.) at new Entry Positions. The shuffling method can be endlessly and randomly varied. I-REC must provide suppressed dashes or arrows to instruct I-GIV before data Entry. Entered values are completely changed.

FIG. 8: The third Entry Form (last). Identical to FIG. 7; new reshuffled Label names have been set (E3, E10, E9, etc.) for the same Entry Positions.

### DESCRIPTION OF THE DRAWINGS FOR THE SECOND, MORE COMPLEX EMBODIMENT, EMB 2.

FIG. 9 Today's Process: Here today's system is shown, with various types of Spyware programs that have infected a PC, modem hijacking, bugging, and generally unprotected data transmission.

FIG. 10 Invention Process: Here the Device is shown, as well as how it places Entry outside the PC, and the VPN tunnel between the Device and the new server set up within the Perimeter 60 at the bank or e-commerce company, military command etc., and how the information passes through the infected PC.

FIG. 11 Normal: This figure shows how the customer returns to the normal PC situation and is able to use the PC in the customary fashion for other services, though with entry still taking place through the Device outside the infected PC environment, thus augmenting the owner's protection against Spyware programs, even for e-mail and other applications as keystroke loggers cannot note keystrokes made outside the PC area via the Device even in Normal mode.

### DESCRIPTION OF PREFERRED EMBODIMENTS OF THE INVENTION. FIRST EMBODIMENT

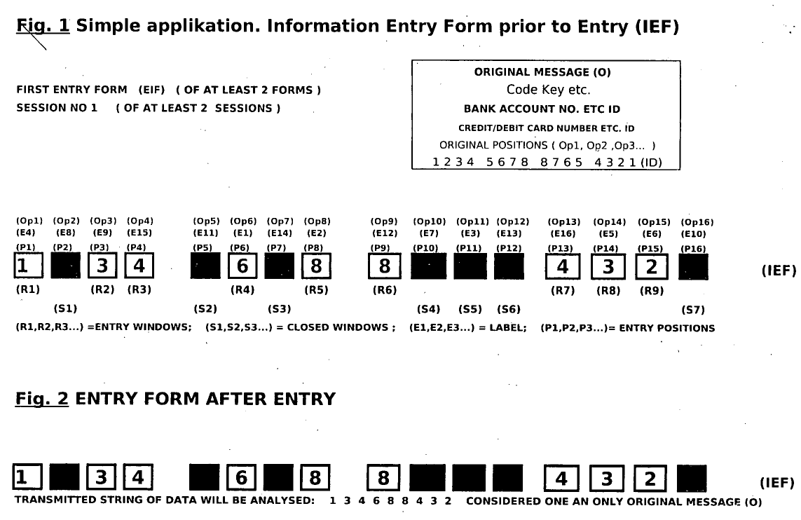

I-GIV connects to the Internet and looks up an Attraction Site whose IP-number is recorded on I-REC's server and is also unwantedly logged by the Spyware programs and eavesdroppers in transit. This is the server's first response to the sender (I-GIV). This may take place using an Alias. The connection can take place manually (EMB 1) or through the Device (EMB 2). I-REC responds in the form of the Initial Entry Form, IEF (FIG. 1).

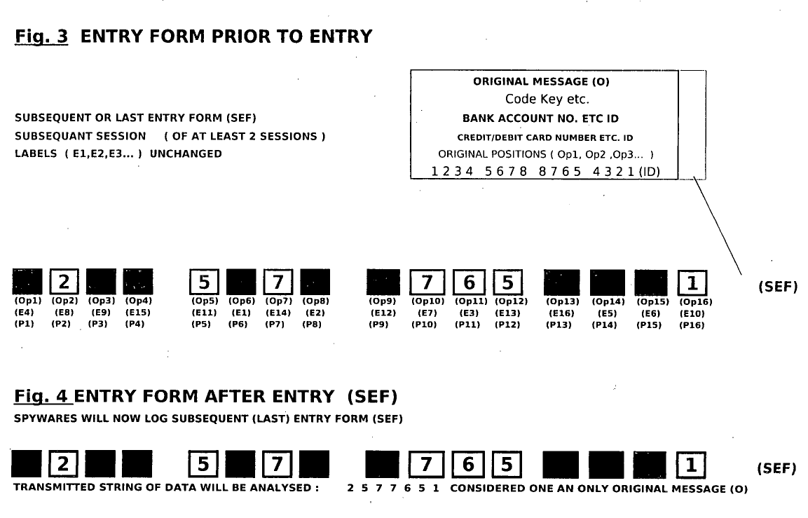

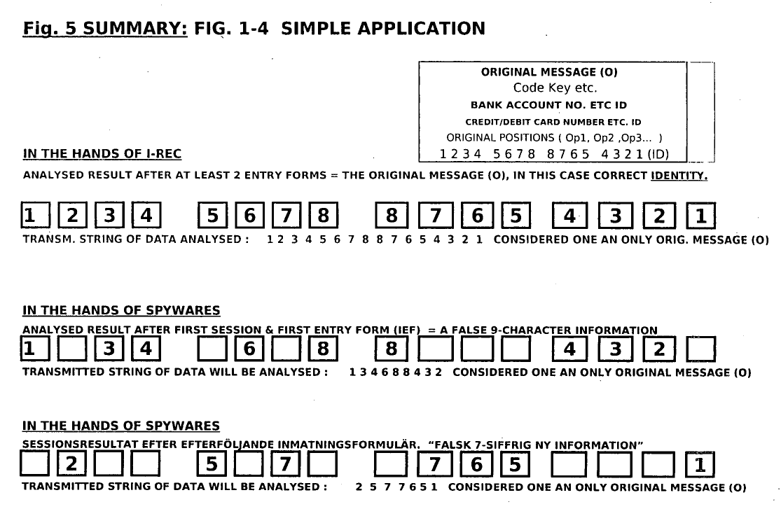

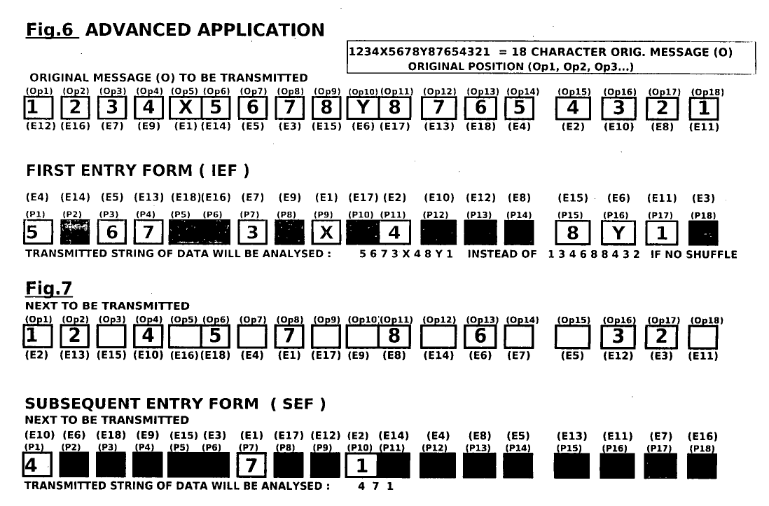

On Entry Forms IEF and SEF, certain Entry Windows (R1, R2, R3, etc.) are open, while others are closed (S1, S2, S3, etc.). They are randomly generated so that the entire Original Message (O) is never revealed on one and the same occasion; when part of O is to be sent, I-GIV sends only those characters of the Original Message (O) that were randomly requested by I-REC. Once the first Entry Form IEF is filled in [see FIG. 2] it is sent to I-REC. Similarly, the subsequent/last Entry Form SEF is transmitted once it has been filled in. (FIG. 4). Together, Entry Forms IEF and SEF(s) constitute Information about the entire Original Message (O). The application of EMB 2 maintains security through the random placement of the Entry Form's open Entry Windows (R1, R2, R3, etc.), which yield false Information when the closed Entry Windows (S1, S2, S3, etc.) are removed upon transmission, thus distorting the Information in the character strings that are transmitted to I-REC (FIG. 2). In simpler application of EMB 2, the Entry Windows are not shuffled, but are rather entered sequentially (where open), (FIG. 1-4). By this simple procedure, Entry and transmission can take place without taking advantage of the possibilities presented by Labels.

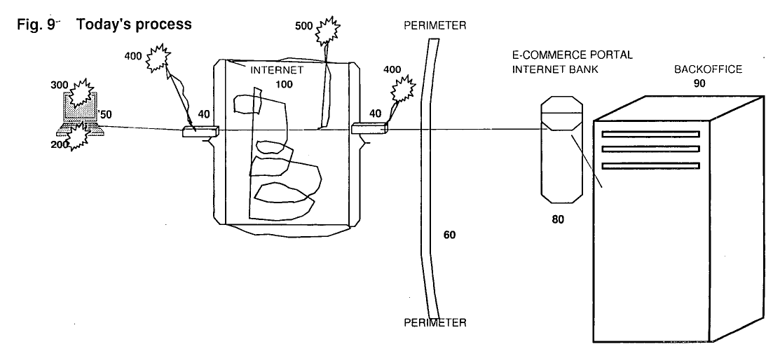

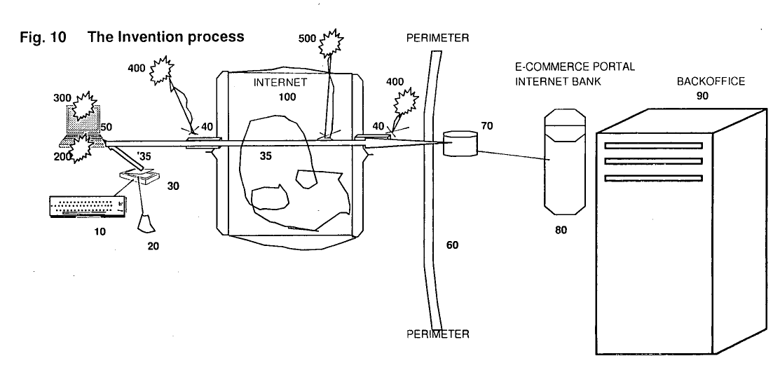

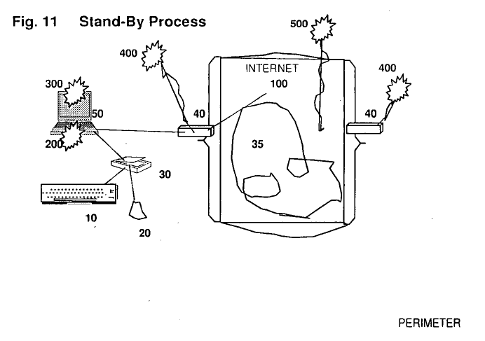

Labels come into play in the invention's more advanced applications (FIG. 6-8) using shuffled Entry Windows. The Labels (E1, E2, E3, etc.) identify a certain Entry Window (R1, R2, R3, etc.; S1, S2, S3, etc.) in relation to the Original Position (Op1, Op2, Op3, etc.). Because the Labels are random, non-repeated, and not identified outside of I-REC's secure environment, nor arranged in order in the transmitted Information Forms (IEF, SEF), nothing can be deduced from the Labels by Spyware programs, though of course the I-REC that created the Labels can make perfect sense of them. In order for I-GIV to be able to know in which Information Window a given value from the Original Position is to be entered, I-REC has provided arrows/dashes in its Entry Forms (FIG. 7) that demonstrate what belongs with what. This can only be seen by the human eye. The Label name never corresponds to the Entry Position's number, and is not repeated in the subsequent form. At I-REC's end, the Labels are able to identify the correct Original Positions (Op1, Op2, Op3, etc.) with regard to the Entry Positions (P1, P2, P3, etc.) from I-GIV (or the Device).

### DESCRIPTION OF PREFERRED EMBODIMENTS OF THE INVENTION. SECOND EMBODIMENT

The Device consists of an apparatus placed outside of I-GIV's PC environment so that the Device's own operating system will not have to use the infected operating system on I-GIV's PC.

Such an external system can be used to perform entry of important data which only afterwards passes through the area controlled by Spyware programs, whereby the keystroke-sensitive Spyware programs neither register keystrokes nor note the information passing through the system as the malicious codes are designed to note specific unencrypted information, sole, and gets only a long string with an “uninteresting” pre-encrypted content. The screen-capturing Spyware programs likewise receive only pre-encrypted “uninteresting” Information both ways. The invention's central role in the protection provided by the Device against Spyware & Rootkit programs thus lies in processing the greatest possible amount of information outside of the direct infected environment by avoiding existing, potentially infected operating systems in PCs, LapTops, mobile phones etc. At the same time, the other services provided by the existing PC are made use of, such as power supply, certain encryptions, broadband access, printing features, encrypted data storage and ability to receive data. A user is able to continue his daily routines on his PC through the Device; when a financial transaction comes up, the user is able to move to the strictly secure inside environment offered by the Device.

The Device therefore consists of at least 2 USB communication ports, or ports with the similar functions, whereof at least one such port connects the Device to the PC. The PC's keyboard or other peripheral is connected to a keyboard port suitable to the make of the PC. Likewise for the mouse or other peripheral. The Device is as well serving ports for an extra screen and/or a touch screen for the first time adapting the PC environment to the well known requirements by elderly and/or disabled having great difficulties with standard keyboards and screens.

The Device is connected to the PC so that it can give instructions, give printing orders, retrieve or deliver encrypted data in storage in the PC, communicate directly with the bank server and be supplied with power.

The USB function will replace the need of ports for keyboard and mouse. The Device contains a card-reader for a SIM card along with its code keys (private keys as well as, potentially, Aliases and IPs), which have been generated in advance and at the Attraction Site owner's initiative (I-REC) i.e. the Internet Bank, and of which I-GIV has been informed in an appropriate fashion, and regarding which an agreement has been reached as to the conditions that apply to the session and to the period of time prior to replacement of the secret codes.

The Device is equipped with an operating system other than that in I-GIV's PC in order to eliminate viral cross-infection from the PC's environment; in order to cross-infect the Device, a virus would have to be sufficiently specialized to be able to handle two simultaneous operating systems, i.e. by first passing through one type, only to be greeted by another. Such viruses do not exist today, adding to the invention's unique position. Because its tasks are so sharply limited, the operating system in the Device can be extremely simple, thus reducing vulnerability to viral attacks in like proportion. (The current virus infections and flaws of the present operating systems come of that those must provide and operate a large number of different features and softwares to be attractive to many kinds of customers' interests, which in turn exposes the operating systems to a multi-feature application difficult to overview and to fully protect against security holes. On the other hand, the slimmer operating system the less features available but the more easy to protect/patch.)

The Device has a display that displays Entries. I-GIV's PC screen is not used at all, providing protection against certain Rootkits. The Device routs all activities significant to local eavesdropping to the Device, turning the PC into a mere “client.” The Device enables must faster, automated routines, and is able to conduct Interactivities completely automatically, such that all data transfer takes place automatically, machine-to-machine, M2M, excluding manual mistakes.

By routing the most important functions needed by Spyware programs for their activities to the Device, e.g. keyboard, easily infected operating system, stored Interactive bank codes, hard disk, and a display instead of the present PC screen, security is optimized for Internet banking, e-commerce, etc. This arrangement does not prevent certain types of Information from being stored in the PC, however, encrypted by the Device.

In complex applications of the invention, I-GIV or the Device chooses an Alias and calls I-REC in a new Session. In simpler cases with only a few (at least 2) Entry Forms, the information exchange continues in the form of “question-response-new question” without an Alias.

FIG. 9 is a schematic demonstration, using prior art technique, of how transfer takes place between a PC 50 at I-GIV (i.e. an Internet Banking customer) and a web portal at I-REC (i.e. an Internet bank) and re-routed to its back office. As shown in FIG. 9 the transfer is made via the Internet 100.

The customer's PC 50 may be host to a number of Spyware programs. Accordingly, “keystroke loggers” 200 are able to scan keystrokes on the customer's keyboard and “screen dump loggers” 300 are able to scan the PC's screen for data to and from I-REC. Connected to the Internet 100 the transfer takes place by means of servers 40, whereby additional Spyware programs 400,500 are able to capture desirable information, such as through what are referred to as PC-Zombies or through wire tap. All of this takes place before the transfer has reached the bank's server 70 or 80 located inside the bank Perimeter 60.

FIG. 10 is a schematic representation of how transfer takes place between a PC 50 and an Internet bank's web portal for re-routing to back office 90, where transfer takes place by means of the Device as to the EMB 2 of the present invention. FIG. 10 demonstrates in which way the Device 30 is connected to the PC 50. Because the Device 30 has its own operating system, of a kind other than the operating system on the PC 50, the transfer sent from the Device 30, via the PC 50, will take place within a VPN-tunnel 35. That makes it more difficult or impossible for Spyware programs to eavesdrop on the transfer. The keyboard 10 of the PC 50 is moved from the PC port to the keyboard port of the Device 30. The direct communication between the Device 30 and the bank server 70 or 80 can now take place by upholding a the VPN-tunnel 35. Important is that both ends—Device 30 and bank server 70 or 80, use the equal encryption protocol which as well is ensured by the previous internal agreement of how transfers shall be made, encrypted, data parts assembled and decrypted as to the private keys and hash agreed on.

### DESCRIPTION OF PREFERRED APPLICATIONS OF THE INVENTION. COMMON TO BOTH EMBODIMENTS

The Information entered and then transmitted by I-GIV to I-REC forms the basis for the Entry Windows which are then to be displayed to I-GIV. Questions responded to earlier are never asked again.

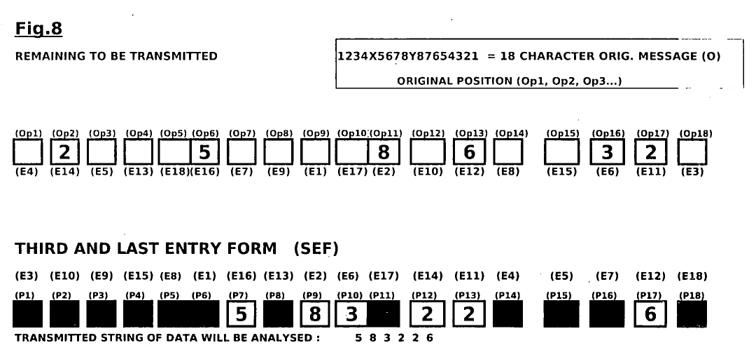

A subsequent Entry Form, SEF, or in simpler cases the last Entry Form, SEF, is displayed on I-GIV's screen. This form looks identical to the one data was entered into earlier, yet with the difference that the Entry Windows filled in before are now closed to new Entry, and the earlier value is not displayed there (FIG. 1-8).

In a complex application of the invention, the closed Entry Windows (S1, S2, S3, etc.) are filled with false background information generated by I-REC. This information may also be visible on I-REC's screen. I-REC ignores such Information, yet Spyware and wire tap programs do not and get mislead.

In another application, the closed Entry Windows (S1, S2, S3, etc.), can be filled in by I-GIV using suppressed false characters above each of these windows, which misleads the types of Spyware programs that both take screen captures and react to keystrokes. The suppressed false characters above the windows are Entered into the closed Entry Windows (S1, S2, S3..etc.) below, and will thus be confused with the correct characters in the bordering Entry Windows. I-REC ignores such Information, yet Spyware and wire tap programs do not.

Another way is to perform the data entry process in a large series of Interactive steps described in the same way, where the sum of discrete Entries from a corresponding number of Sessions constitutes the Original Message (O).

The invention may therefore come to consist of alternating Sessions in a multi-part arrangement, i.e. whereby I-REC in its response to I-GIV issues a notification that a connection is to be established with at least one third party (new I-REC, new I-RECs) where I-GIV is to submit one or more subsequent Entry Forms (SEF). In a more advanced form of this multi-part arrangement, additional subsequent parties (I-REC) may exist, to which I-GIV submits additional subsequent Entry Forms, until at last the final Entry Form is submitted to the last of such additional I-RECs. The same model can be used for more than one I-GIV (see below).

In certain cases, it may happen that the Original Message consists of Information other than an Identity, and that the number of characters in the Original Message is initially unknown to I-REC, e.g. text/s or other larger pieces of encrypted information. (i.e for military use, long messages). In this case, in its first connection to I-REC, I-GIV will need to submit the total number of characters (including any spaces/blanks) included in the original information with a request that the Information Forms be generated in keeping with that number. Spyware programs that are able to compile values from several sessions will still perform their analyses in vain (FIG. 6, 7, 8).

In another advanced form of the invention, after receiving the Entry Form from I-REC, I-GIV can choose to hand off the continued Session procedure to another I-GIV, which then takes over and similarly continues the alternating exchange of the subsequent Information Forms. Thus, in order to utilize all the invention's potential to evade local eavesdropping, there is no limit to the number of I-GIVs or I-RECs that can be used.

The invention's combination of randomization, character shuffling, false information, unexpected change of I-GIV and/or I-REC, connect & disconnect, change of IP numbers for next session when Session changes thus creates a variety of highly innovative functions that disrupt the limited number of criminal procedures employed by advanced Spyware programs for the purpose of local eavesdropping. The malicious programs are designed to look for certain facts as to design. They cannot alter in case the circumstances alter. Thus they are not yet smart and logical. If they don't find exactly what they are looking for it will be neglected. The invention uses this and becomes able to fully mislead them all heavily securing each kind of authentication, Identity and data exchange.

In the EMB 2 of the invention I-REC consists of at least one server. All communication between the server/servers on one end and the Device on the other takes place through the VPN tunnel mentioned above. The question forms are designed in keeping with I-REC's requirements irrespectively of usage in EMB 1 or EMB 2 of the present invention or in both of them. This makes the invention platform-independent, since it delivers precisely the information format that I-REC is designed to accept. This is highly important i.e in EMB 2 of the invention, i.e. for Internet banks, since they would otherwise have to make large modifications to their internal data structure and become reluctant to the costs to implement the new technique. Of this reason EMB 2 of the invention requires an extra server inside the bank Perimeter 60 being one of the endpoints “interpreting/translation the incoming Information to the expected format of data set by the bank and vice versa to the other endpoint—the Device. One might say that, by using the invention, and in particular its EMB 2 consisting of a Device and SIM card, the information that is currently displayed and written on the customer's screen can instead be written onto a “screen” that lies within I-REC's Perimeter 60. One might say that the process is “moved from the customer's screen to the bank.” Thus, the format will remain the same as what the back offices have been designed to accommodate today.

Linking the Invention to CVV2 Codes and Extra Code

An additional application of the invention in (i.e. in its EMB 1 for e-commerce and card-not-present purchases online) is to utilize the CVV2 code—inserted by means of the Entry Form technique described above—in order to ward off certain types of Phishing (false bank and e-commerce websites) and thus simultaneously secure the Identity both of I-GIV (the online buyer or Internet bank customer or else) and I-REC (the e-commerce page, card reader or Internet bank or else).

In a complex model of the invention, there is an additional separate multi-position Information recipient identifier printed on the bank card by the bank card company or card issuer. The code is a parallel code to the CVV2 code—an extra code to authenticate the I-REC itself—, and this method is intended to eliminate Phishing at the Information Recipient end in that none other than I-REC and I-GIV (with his bank card in hand) will know this Anti-Phishing code. This code is handled using a separate Entry Form, yet in the opposite direction, since in this case I-REC is obliged to prove its identity to I-GIV.

This proceeds in that I-GIV requests an initial and then a second Entry Form from I-REC with a number of characters from the actual code filled in as Information from the code's Original Message—not all characters, since this would exhaust the code more quickly due to the risk of eavesdropping. There is yet no system invented to authenticate the I-REC to I-GIV. In e-commerce I-GIV simply hopes there is the true I-REC on the webshop side. The inventions break this.

1. Method for presenting information in connection with the distribution of the same via the Internet and/or other media, whereby the information is in the form of a quantity of characters (O), whereby the information is transferred from an information giver (I-GIV) to an information recipient (I-REC), whereby the information is transferred in at least two Sessions that, in the first Session, the information giver (I-GIV) fills out the initial entry form (IEF), that a first partial quantity of the total quantity of characters is entered into the initial entry form (IEF), that the information in the completed initial entry form (IEF) is transferred from the information giver (I-GIV) to an information recipient (I-REC), that the information giver (I-GIV) fills out a second entry form (SEF)in a second Session, that a second partial quantity of characters of the total quantity is entered into the second entry form (SEF), and that additional sessions of data transfer take place as needed via the completion of additional entry forms (SEF), until the entire quantity of characters has been transmitted from the information giver (I-GIV) to the information recipient (I-REC), characterized in that I-GIV fills out the partial character quantity associated with each session in randomly generated open entry windows (R1, R2, R3, etc.) in the entry forms (IEF, SEF), and that closed entry windows (S1, S2, S3, etc.) are provided between certain of the open entry windows (R1, R2, R3, etc.) in the entry form (IEF, SEF).

2. Method according to claim 1, characterized in that before information is transferred to I-REC, the closed entry windows (S1, S2, S3, etc.) are removed, and that the partial quantities of the total quantity entered are compressed.

3. Method according to claim 1, characterized in that before information is transferred to I-REC, I-GIV ensures that the closed entry windows (S1, S2, S3, etc.) are furnished with characters that frustrate unauthorized access to the information.

4. Method according to claim 1, characterized in that the closed entry windows (S1, S2, S3, etc.) are furnished with characters that frustrate unauthorized access to the information.

5. Method according to claim 2, characterized in that at least one character of the total quantity of characters transferred be entered into every open entry window (R1, R2, R3, etc.).

6. Method according to claim 2, characterized in that one character of the total quantity of characters transferred be entered into every open entry window (R1, R2, R3, etc.).

7. Method according to claim 2, characterized in that each of the characters included in the total quantity of characters (O) defines an original position (Op1, Op2, Op3, etc.), and that at least certain of the original positions (Op1, Op2, Op3, etc.) be furnished, by the information recipient (I-REC), with a randomly selected label (E1, E2, E3, etc.), and that the open entry windows (R1, R2, R3, etc.) for at least certain characters have a sequence that deviates from the original positions' (Op1, Op2, Op3, etc.) sequence in the entry form (IEF, SEF).

8. Method according to claim 7, characterized in that the open entry windows (R1, R2, R3, etc.) having a sequence that differs from the order of the original positions (Op1, Op2, Op3, etc) in the entry form (IEF, SEF), are associated with original positions (Op1, Op2, Op3, etc.) that are furnished with a label (E1, E2, E3, etc.).

9. Method according to claim 1, characterized in that the information recipient (I-REC) can vary across Sessions.

10. Method according to claim 1, characterized in that several information recipients (I-REC) can be involved in a single Session.

11. Method according to claim 1, characterized in that the information giver (I-GIV) can vary across Sessions.

12. Method according to claim 1, characterized in that several information givers (I-GIV) can be involved in a single session.

13. Hardware device where device is intended to be connected to an existing PC, where the device comprises a processor, memory, a card reader or CD reader, a SIM card or Smartcard with the correct authorization code, a display and at least two USB ports, where one USB port is for connecting a keyboard and the other for connection to the PC; and which hardware device is characterized by the fact that it has its own operating system.

14. Hardware device where device is intended to be connected to an existing PC, where the device comprises a processor, a memory, a card reader or CD reader, a SIM card or Smartcard with the correct authorization code, a display and at least two USB ports, where one USB port is for connecting a keyboard and the other for connection to the PC, characterized in that the device has its own operating system.

15. Device according to claim 13, characterized in that the operating system in the device and the operating system in the PC only need to communicate with each other in order to perform the functions necessary for carrying out the method according to the present invention.

16. Device according to claims 13, characterized in that the device comprises means for encrypting the information that leaves the device.

17. Device according to claim 13, characterized in that the device is activated when the SIM card/Smartcard is inserted into the card reader.

18. Device according to claim 13, characterized in that it comprises or generates an entry form (IEF) with open entry windows (R1, R2, R3, etc.) and closed entry windows (S1, S2, S3, etc.).

19. Device according to claims 14, characterized in that the device comprises means for encrypting the information that leaves the device.
